(19) United States
(12) Patent Application Publication
(10) Pub. No.: US 2016/0193618 A1
(43) Pub. Date: Jul. 7, 2016

(54) DELIVERING DEVICE, IN PARTICULAR FOR PASTY OR CREAMY PRODUCTS

(71) Applicant: STAN ENGINEERING CORP. S.R.L., Salmour (CN) (IT)

(72) Inventor: Alessandro Sacchet, Salmour (CN) (IT)

(21) Appl. No.: 14/911,453

(22) PCT Filed: Aug. 12, 2014
(86) PCT No.: PCT/IT2014/000215

§ 371 Date: Feb. 10, 2016

(30) Foreign Application Priority Data
Aug. 12, 2013 (IT) TO2013A000689

(51) Int. Cl. B05B 11/00

(52) U.S. Cl. CPC B05B 11/3052; B05B 11/3045

(57) ABSTRACT

A delivering device (1) is described, in particular for pasty or creamy products preferably for domestic use, comprising at least one delivery duct (3) which puts in fluid communication at least one internal volume (5) of at least one container (7), the internal volume (5) containing therein at least one product, and at least one delivery nozzle (9) for exiting the product by interposing pumping means (11) actuated by at least one actuating motor (13) to transfer amounts of the product from the internal volume (5) to the delivery nozzle (5) through the delivery duct (3), and control means (14) actuated by a user and operatively cooperating with the actuating motor (13) to allow or inhibit at will an operation of the actuating motor (13) and perform or stop a delivery of the product through the delivery nozzle (9).

The present invention refers to a delivering device, in particular for pasty or creamy products, preferably aimed for domestic use.

Many commonly used products are known in the art, such as for example foodstuff (sauces, creams, etc.), cosmetics and soaps having pasty or creamy consistence with classical reologic properties.

The products are usually sold in cans or small tubess so that the end user must then proceed, in order to use them, to take them from the containers either through a suitable tool (spoon, fork, knife, spatula, etc.) or through compression in order to deliver them from their related tube.

The art further proposes systems and devices which allow delivering and automatically batching pasty products like those disclosed, for example, in CN101922955, DE102007024722, EP1399370, EP0428883.

Object of the present invention is solving the above prior art problems, by providing an alternative delivering device which allows to practically, quickly and automatically deliver and possibly batch pasty or creamy products, such as food products, cosmetics, soaps, etc., preferably in a domestic use environment.

Another object of the present invention is providing a delivering device which allows to practically, quickly and automatically deliver and possibly batch pasty or creamy products directly from their own container, being both a can or a small tube.

The above and other objects and advantages of the invention, as will result from the following description, are obtained with a delivering device as claimed in claim 1. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could be made to what is described, without departing from the scope of the invention as appears from the enclosed claims.

The present invention will be better described by some preferred embodiments thereof, provided as a non-limiting example, with reference to the enclosed drawings, in which:

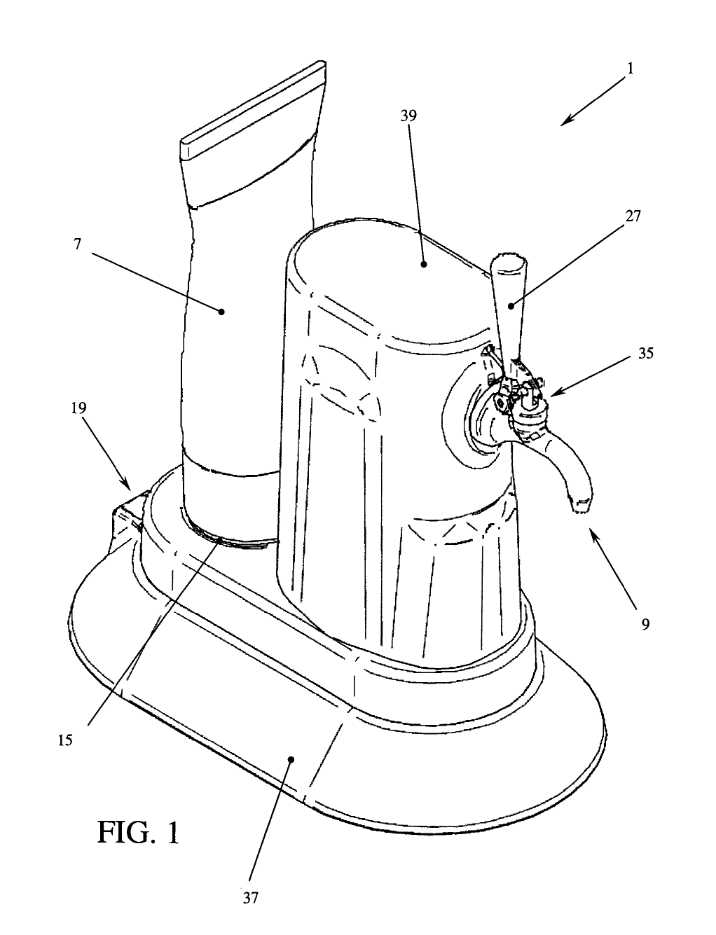

FIG. 1 shows a top perspective view of a preferred embodiment of the delivering device according to the present invention;

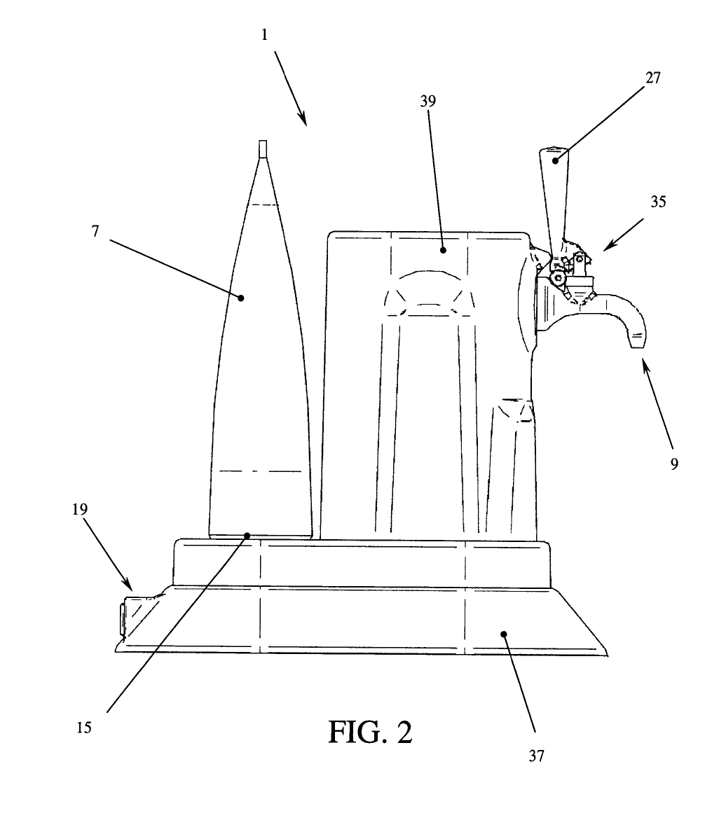

FIG. 2 shows a side view of the delivering device of FIG. 1;

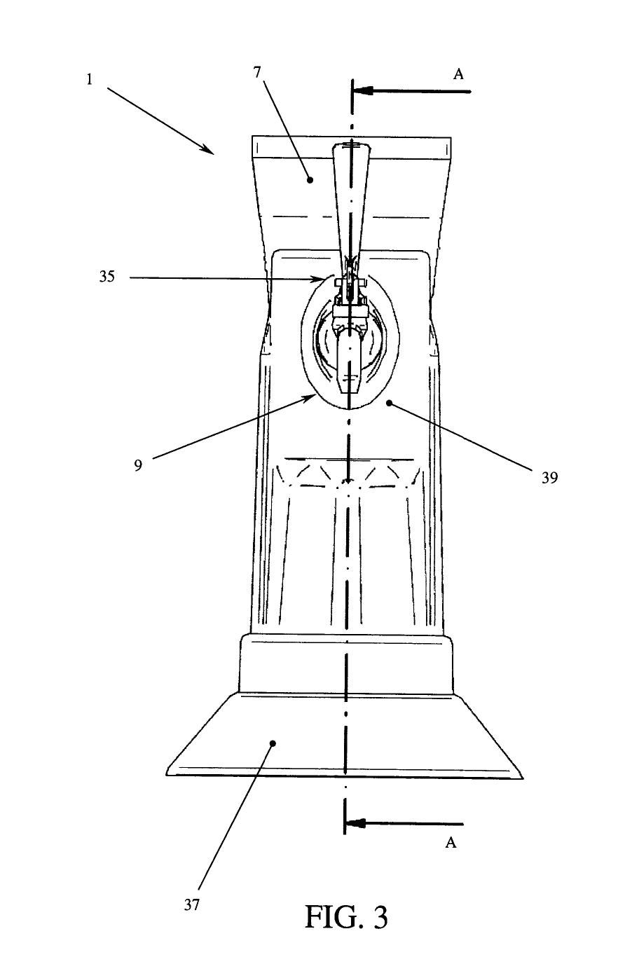

FIG. 3 shows a front view of the delivering device of FIG. 1;

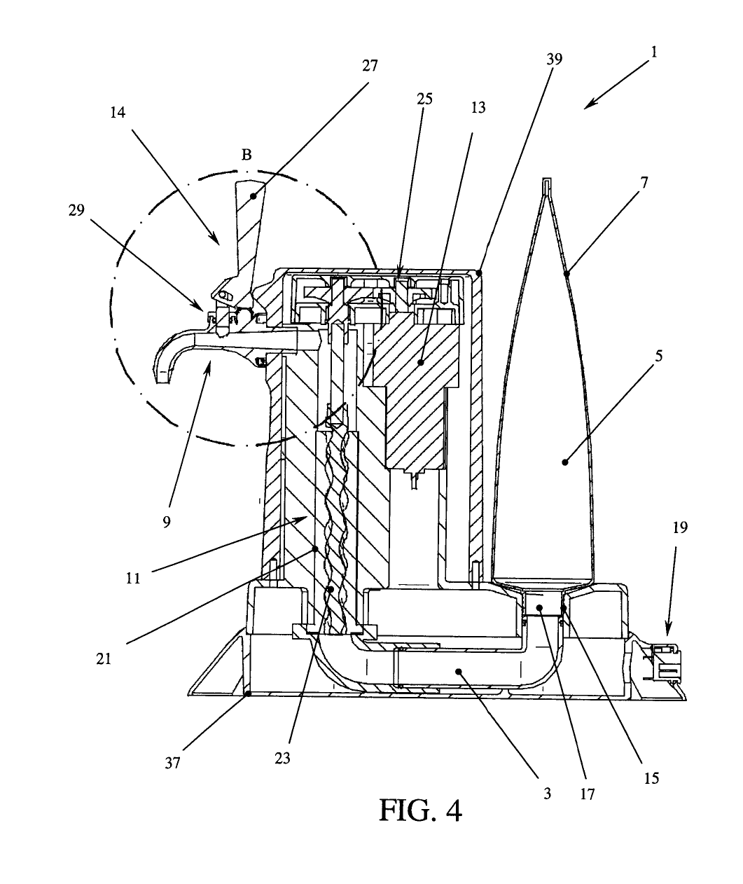

FIG. 4 shows a sectional view of the delivering device according to the present invention along section line A-A of FIG. 3; and

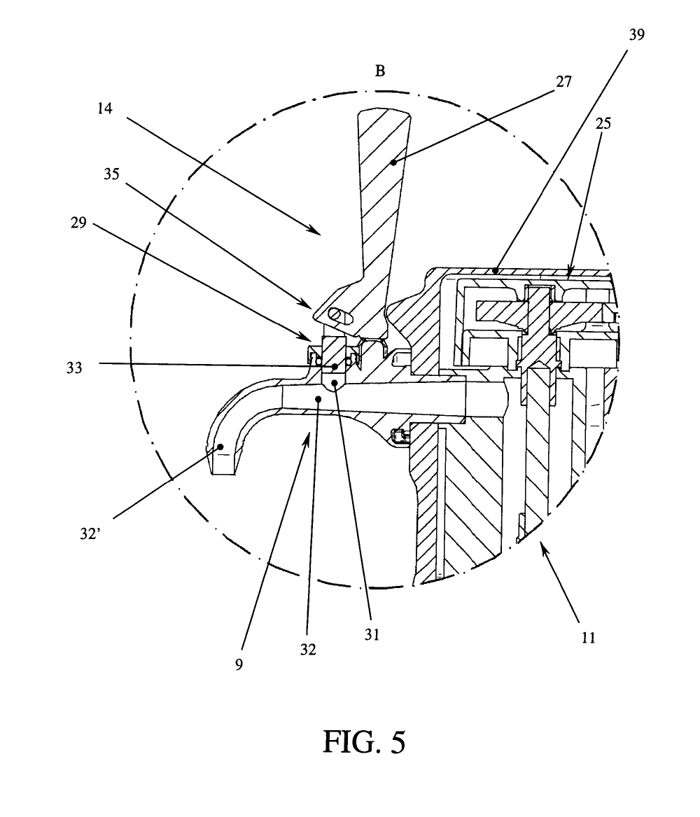

FIG. 5 shows an enlarged view of the detail enclosed in circle B of FIG. 4.

With reference to the Figures, it is possible to note that the delivering device 1, in particular for pasty or creamy products such as for example soaps (toothpastes, etc.), cosmetics, foodstuff (creams, sauces, etc.) according to the present invention, preferably for domestic use, comprises at least one delivery duct 3 which fluid communicates at least one internal volume 5 of at least one container 7, the internal volume 5 containing therein at least one product, and at least one delivery nozzle 9 for exiting the product, by interposing pumping means 11 actuated by at least one actuating motor 13 for transferring product amounts from the internal volume 5 to the delivery nozzle 5 through the delivery duct 3.

The delivering device 1 according to the present invention further comprises suitable control means 14 actuated by a user and operatively cooperating with the actuating motor 13 to allow or inhibit at will the operation of the actuating motor 13 itself and respectively perform or stop the delivery of the product through the delivery nozzle 9.

Advantageously, the container 7 is a common container for selling the pasty product contained in its internal volume 5, and in particular it can be a common can or small tube (as shown in the Figures as an example): for such purpose, the delivery duct 3 can have an end equipped with at least one connecting neck 15 to an opening 17 of the container 7 communicating with the internal volume 5, the opening being preferably the product delivery neck from the container, usually closed by the respective pretecting cover. Preferably, the connecting neck 15 can allow a connection of the opening 15 through a simple connection due to elastic interference or engagement: alternatively, it is possible to provide that the connecting neck internally comprises at least one suitable threading corresponding to the common threading present outside the opening 15 for screwing the related protecting cover, in order to allow the connection of the container 7 to the connecting neck 15 through a similar screwing. In addition, it is possible to provide that the delivering device 1 according to the present invention comprises one or more interchangeable adapters (not shown) which can be inserted inside the connecting neck 15 to indifferently allow the connection, by elastic interference, engagement or screwing, of any one of the usually marketed containers 7 having, as known, openings 15 with mutually different threading diameters and/or pitches.

Obviously, the delivering device 1 according to the present invention can further comprise electric supply means for the actuating motor 13, being either antonomous and on board the same device 1 (such as, for example, one or more electric batteries, preferably of the rechargeable type) or comprising connection means 19 to a common electric supply mains outlet.

Preferably, the pumping means 11 comprise at least one pump with progressive recesses driven to rotate by the actuating motor 13. In particular, the pump with progressive recesses, arranged coaxially with the delivery duct 3, is substantially composed of an external stator casing 21 and of an internal rotor 23, driven to rotate by the actuating motor 13 to whose rotation shaft it can be connected directly or by interposing a suitable motion transmission kinematism 25 (such as, for example, a kinematism with a cascade of gears connecting the drive shaft of the actuating motor 13 to the internal rotor 23, like the one shown in particular in FIG. 4), the internal rotor 23 being shaped as worm screw with progressive recesses whose relative rotation with respect to the stator 21 generates a translation movement of the product therein. In particular, when actuated by the actuating motor 13, the pump with progressive recesses, during the rotation movement of its internal rotor 23, transfers certain volumetric amounts of the pasty or creamy product from the internal volume 5 of the container to the delivery nozzle 9 by interposing the delivery duct 3.

In particular, the control means 14, comprising at least one control lever 27 which can be actuated by a user, are adapted to pass from a control position of the actuation of the operation of the actuating motor 13, and then allow the delivery of the product through the delivery nozzle 9, to an inhibition position of the operation of the actuating motor 13, and then allow the delivery of the product through the delivery nozzle 9, and vice versa. Moreover, the control means 14 cooperate with at least one dripping-preventing system 29 preferably arranged along the delivery nozzle 9: in particular, the system 29 comprises at least one recess 31 in fluid communication with the section of delivery duct 32 of the nozzle 9 in a position included between the pumping means 11 and an end section 32′ of the section of delivery duct of the nozzle 9, the recess 31 containing therein at least one sliding element 33 cooperating with the control means 14 in order to pass, by sliding inside the recess 31, from a first position with at least partial occupation of the internal volume of the recess 31 itself, when the control means 14 are in their control position of the actuation of the operation of the actuating motor 13, to a second position of at least partial disengagement of the internal volume of the recess 31, when instead the control means 14 are in their inhibition position of the operation of the actuating motor 13. In particular, the sliding element 33 can operatively cooperate with the control lever 27 by interposing a suitable hinge- or cam-type kinematism 35 for making the above described sliding movement inside the recess 31.

Advantageously, therefore, when the control means 14 are taken to their control position of the actuation of the operation of the actuating motor 13, the sliding element 33 is at the same time taken to its first position by sliding inside the recess 31 in order to at least partially occupy its internal volume without impairing the product passage through the section of delivery duct 32 of the nozzle 9; when instead, at the end of the desired delivery, the control means 14 are taken back to their inhibition position of the operation of the actuating motor 13, and therefore the product passage through the section of delivery duct 32 ceases, the sliding element 33 is taken to its second position by sliding inside the recess 31 in order to at least partially free its previously occupied, internal volume and performing a suction action, inside the volume itself of the recess 31, of the product remained inside at least the end section 32′ of the section of delivery duct 32 of the nozzle 9, consequently avoiding any dripping outside.

In addition, the control means 14 can cooperate with control means (not shown) preferably made as a suitable electronic card, cooperating with the actuating motor 13, for automatically managing the operation of the pumping means 11 depending on the delivery of amounts of the product having a batching, preset or adjustable by the user. In particular, alternatively or in addition to the previously described dripping-preventing system 29, the control means could also cooperate with the actuating motor 13 so that, once having ended the delivery of the product, they drive the actuating motor 13 in order to impose to the internal rotor 23 a counter-rotation of a suitable entity as to suck part of the product remained inside the section of delivery duct 32, consequently avoiding possible drippings at delivery nozzle 9 level.

Moreover, the container 7 can be equipped with suitable recognizing means (not shown), such as for example a RFID label, externally arranged in a suitable position, adapted to identify at least the type of pasty or creamy product contained in its internal volume 5 and cooperating with related reading means of the recognizing means, so that the control means are able to know the exact type of pasty product contained inside the container 7, for example in order to suit the batching and delivering modes of the delivering device 1 depending on specific properties and reologic and viscosity features of the product.

Obviously, the delivering device 1 according to the present invention can further comprise a suitable supporting and containing structure adapted to support and contain the above described components. In particular, the structure can comprise at least one supporting base 37 comprising the above connecting neck 15 of the container 7 and at least one covering and protecting carter 39 at least of the actuating motor 13 and of the pumping means 11.

1. A delivering device in particular for pasty or creamy products comprising at least one delivery duct which puts in fluid communication at least one internal volume of at least one container, said internal volume containing therein at least one said product, and at least one delivery nozzle for exiting said product, by interposing pumping means actuated by at least one actuating motor to transfer amounts of said product from said internal volume to said delivery nozzle through said delivery duct, and control means actuated by a user and operatively cooperating with said actuating motor in order to allow or inhibit at will an operation of said actuating motor and perform or stop a delivery of said product through said delivery nozzle, said pumping means comprising a pump with progressive recesses driven to rotate by said actuating motor, said pump with progressive recesses being composed of an external stator casing and of an internal rotor driven to rotate by said actuating motor, said internal rotor being shaped as a worm screw with progressive recesses, characterized in that said control means are adapted to pass from a control position of the actuation of the operation of said actuating motor to an inhibition position of the operation of said actuating motor and vice versa, said control means cooperating with a dripping-preventing system comprising at least one recess in fluid communication with a section of delivery duct of said nozzle in a position included between said pumping means and an end section of said section of delivery duct of said nozzle, said recess containing therein at least one sliding element cooperating with said control means in order to pass, sliding inside said recess, from a first position of at least partial occupation of an internal volume of said recess, when said control means are in said control position of the actuation of the operation of said actuating motor to a second position of at least partial disengagement of said internal volume of said recess, when said control means are in said inhibition position of the operation of said actuating motor.

2. The delivering device according to claim 1, characterized in that said delivery duct has an end equipped with at least one connecting neck with an opening of said container communicating with said internal volume.

3. The delivering device according to claim 1, characterized in that said connecting neck is adapted to allow a connection of said opening through connection by elastic interference or engagement.

4. The delivering device according to claim 2, characterized in that said connecting neck internally comprises at least one threading corresponding to a threading present externally to said opening to allow a connection of said container to said connecting neck through screwing.

5. The delivering device according to claim 2, characterized in that it comprises one or more interchangeable adapters which can be inserted inside said connecting neck to allow a connection, by elastic interference, engagement or screwing of any one of said containers.

6. The delivering device according to claim 1, characterized in that said control means comprise at least one control lever which can he actuated by a user, said sliding element operatively cooperating with said control lever by interposing a kinematism to perform said sliding movement inside said recess.

7. The delivering device according to claim 1, characterized in that said control means cooperate with control means of said actuating motor to automatically manage an operation of said pumping means as function of a delivery of amounts of said product having a hatching preset or adjustable by a user.

8. The delivering device according to the claim 7, characterized in that said control means cooperate with said actuating motor in order to impose to said internal rotor a counter-rotation to suck part of said product remained inside said section of delivery duct.

9. The delivering device according to claim 9, characterized in that said container is equipped with recognizing means adapted to identify at least one type of said product contained inside said internal volume and cooperating with related reading means of said recognizing means.
